(19) United States
(12) Patent Application Publication
(10) Pub. No.: US 2026/0204877 A1
(43) Pub. Date: Jul. 16, 2026

(54) SPARK PLUG WITH GROUND ELECTRODE INSERTED INTO THE HOUSING WALL AND WITH IMPROVED HEAT BALANCE

(71) Applicant: Robert Bosch GmbH, Stuttgart (DE)

(72) Inventors: Matthias Blankmeister, Heiligenhaus (DE); Stephan Kaske, Sternenfels Diefenbach (DE)

(21) Appl. No.: 19/137,334

(22) PCT Filed: Dec. 5, 2023
(86) PCT No.: PCT/EP2023/084343

§ 371 Date: Jun. 10, 2025

(30) Foreign Application Priority Data
Dec. 20, 2022 (DE) 10 2022 214 073.7

(51) Int. Cl. H01T 13/32; H01T 13/46; H01T 13/54

(52) U.S. Cl. CPC H01T 13/32; H01T 13/467; H01T 13/54

(57) ABSTRACT

A spark plug with a longitudinal axis. The spart plug includes: a housing with a longitudinal bore parallel to the longitudinal axis of the spark plug, the housing having a housing wall and an interior; an insulator arranged within the housing; a center electrode arranged within the insulator; a ground electrode with a total length and a diameter; a bore in the housing wall with a diameter, wherein the ground electrode is arranged with a length in the bore, and the ground electrode projects with a length from the inner side of the housing wall into the interior of the housing, and wherein the housing wall has a thickness in the region of the bore; and a spark gap formed between the ground electrode and the center electrode.

### FIELD

The present invention is based on a spark plug.

### BACKGROUND INFORMATION

In order for spark plugs and pre-chamber spark plugs to function optimally at all operating points, balanced temperature management is necessary.

New spark plug concepts with the spark gap formed within the housing have increasingly been pursued for some time. In one of these concepts, the ground electrode is inserted in a bore in the housing wall and protrudes laterally from the housing wall into the interior of the housing. German Patent Application No. DE 10 2017 221 517 A describes a pre-chamber spark plug in which the ground electrode is arranged in a bore in the housing wall and protrudes laterally into the interior.

With the new spark plug concepts with a ground electrode arranged in a bore in the housing wall and protruding laterally into the interior, new challenges arise in the temperature management of the spark plug. In today's spark plugs, temperature management is affected by many different factors.

Some of these factors are the material selection, the length of the center electrode and of the insulator, and the structure of the electrodes, with or without copper core, as well as the position of the spark plug in the combustion chamber. In particular in the case of pre-chamber spark plugs, the additional separate combustion chamber within the spark plug is added as a factor. The pre-chamber spark plug must absorb the combustion gases in the spray of the injection nozzles and is thus arranged in a very hot region of the combustion chamber of the engine.

An object of the present invention is to provide a spark plug that has a reliable temperature management.

### SUMMARY

This object may be achieved by the spark plug according to certain features of the present invention.

A spark plug according to an example embodiment of the present invention has a longitudinal axis X, which extends from the end of the spark plug on the combustion chamber side to the end of the spark plug that faces away from the combustion chamber. The spark plug furthermore comprises a housing with a longitudinal bore parallel to the longitudinal axis X of the spark plug, whereby the housing has a housing wall and an interior, as well as an insulator which is arranged within the housing and in which a center electrode is arranged. Furthermore, the spark plug comprises a ground electrode with a total length L_{MaEl} and a diameter D_{MaEl}, a bore in the housing wall with a diameter D_{Bohr}, and a spark gap formed between the ground electrode and the center electrode. The ground electrode is arranged with a length L_{Bohr} in the bore in the housing wall and projects with a length Lₑₘ from the inner side of the housing wall into the interior of the housing. The housing wall has a thickness L_{Wall} in the region of the bore.

Advantageously,
the ratio of the total length L_{MaEl} of the ground electrode to the length L_{Bohr} of the ground electrode in the bore is equal to or greater than 1.8 and equal to or less than 2.2, and/or
the ratio of the length of Lₑₘ, with which the ground electrode projects into the interior of the housing, to the thickness L_{Wall} of the housing wall is equal to or greater than 0.2 and equal to or less than 3, wherein the lengths and the thickness extend perpendicularly to the longitudinal axis X of the spark plug.

This results in a spark plug with improved heat balance.

Due to the advantageous ratio of the total length L_{MaEl} of the ground electrode to the length L_{Bohr} of the ground electrode in the bore of 1.8 to 2.2, a reliable temperature management results in the spark plug. The length L_{Bohr} of the ground electrode in the bore is proportional to the contact area of the ground electrode with the bore. The greater the contact area between the ground electrode and the bore, the better the heat dissipation from the ground electrode into the housing. This ratio according to the present invention of L_{MaEl} to L_{Bohr} results in a sufficiently large contact length of the ground electrode with the bore and the housing wall so that the heat absorbed by the ground electrode in the interior of the housing can be sufficiently dissipated via the contact area in the bore in the housing wall.

Alternatively, according to an example embodiment of the present invention, this technical effect is also achieved if the ratio of the length Lₑₘ, with which the ground electrode projects into the interior of the housing, to the thickness L_{Wall} of the housing wall is equal to or greater than 0.2 and equal to or less than 3. If both advantageous length ratios are met, the desired technical effect of a reliable temperature management is enhanced.

The lengths and the thickness extend perpendicularly to the longitudinal axis X of the spark plug and are measured accordingly.

The aforementioned ratios and difference affect the heat transfer from the ground electrode into the housing and thus the heat balance of the spark plug. Each ratio by itself or the difference results in a spark plug with improved heat balance. The combination of two or all advantageous embodiments of the spark plug according to the present invention leads to an enhancement of the technical effect.

Preferred developments of the present invention are disclosed herein.

In an advantageous example embodiment of the present invention, it is provided that the ratio of the length Lₑₘ, with which the ground electrode projects into the interior of the housing, to the thickness L_{Wall} of the housing wall is equal to or less than 2, in particular 1. The less the ground electrode protrudes into the interior, the less heat the ground electrode can absorb, which heat must be dissipated via the contact area in the housing wall bore. Through the thickness of the housing wall in the region of the bore, the maximum length of the bore, and thus the maximum length that the ground electrode can be inserted in the bore, is also specified. The thickness of the housing wall thus also affects the maximum contact area between the ground electrode in the bore and the housing, wherein the size of the contact area affects the quality of the heat dissipation and of the temperature management.

In a development of the present invention, it is provided that the ground electrode has a total length L_{MaEL} of equal to or greater than 2.0 mm and equal to or less than 4.0 mm. This limitation of the length of the ground electrode ensures that the ground electrode is neither too short nor too long. In the case of a ground electrode that is too short, the contact length in the housing wall bore may be too short for sufficient heat dissipation. In the case of a ground electrode that is too long, the ground electrode absorbs more heat and a correspondingly longer contact area in the housing wall bore would be required for sufficient heat dissipation. For the common types of spark plugs with different dimensions, the upper and the lower limit values for the length of the ground electrode constitute a good compromise between a sufficiently long ground electrode for a good contact length and a not too long ground electrode, which absorbs more heat than can be dissipated.

In another advantageous example embodiment of the present invention, it is provided that the length L_{Bohr} of the ground electrode in the bore and/or the thickness L_{Wall} of the housing wall is equal to or greater than 1.0 mm and equal to or less than 2.5 mm. In particular, it is advantageous if the length L_{Bohr} of the ground electrode in the bore is equal to the thickness L_{Wall} of the housing wall, so that the ground electrode has the maximum possible contact area on the one hand and the ground electrode also closes off the bore flush with the housing exterior, which simplifies the production of the spark plug in comparison to a ground electrode that ends within the bore or ends outside the bore.

In a further advantageous example embodiment of the present invention, it is provided that the ground electrode protrudes with a length Lₑₘ of equal to or greater than 0.6 mm and equal to or less than 1.6 mm into the interior. The upper limit for the length Lₑₘ, with which the ground electrode protrudes into the interior, ensures that the ground electrode does not protrude too far into the interior and thus does not absorb too much heat, which is then dissipated again via the housing.

In a development of the present invention, the ground electrode has an electrode base body and a precious-metal-containing element with a diameter D_{EM}, wherein the electrode base body is at least partially arranged within the bore and has a diameter D_{MaEl} within the bore, and wherein the precious-metal-containing element is attached to the electrode base body. Advantageously, a ratio between the diameter D_{EM} of the precious-metal-containing element and the diameter D_{MaEl} of the electrode base body in the bore is equal to or less than 1 and equal to or greater than 0.4. This results in the different coefficients of thermal expansion of the precious-metal-containing element and of the electrode base body being balanced.

In combination or alternatively, it is provided in further embodiments of the present invention that the spark gap between the center electrode and the ground electrode is a radial spark gap, and/or that the spark gap is at least partially, in particular entirely, formed within the interior of the housing.

In one advantageous development of the present invention, the spark plug has a second ground electrode that, like the first ground electrode, is arranged in a further bore in the housing wall. For the second ground electrode, the same advantageous configuration and the same advantageous length ratios apply as for the first ground electrode.

It has been found to be advantageous for the ground electrode and/or the second ground electrode to be crimped in the bore and/or welded to the housing wall.

For a spark plug with a pressed ground electrode, improved heat balance results if the magnitude of the difference between the diameter of the ground electrode and the diameter of the bore is equal to or less than 0.03 mm. The smaller the difference, the better the fit between the ground electrode and the housing so that good heat transfer between the ground electrode and the housing results. This also results in a good holding force so that the ground electrode is reliably placed in the bore and does not slide in the bore or even fall out of the bore.

For a spark plug with a ground electrode welded in the bore, a good heat balance results if the weld seam between the ground electrode and the housing wall has a length L_{SN} of not greater than 0.9*thickness I_{Wall} of the housing wall and in particular not less than 0.3*thickness L_{Wall} of the housing wall. For example, it is also advantageous if the length of the weld seam is equal to or greater than 0.5*thickness I_{Wall} of the housing wall and/or equal to or less than 0.7*thickness L_{Wall} of the housing wall.

In one advantageous development of the present invention, it is provided that the spark plug has a cap, which is attached to the end of the housing on the combustion chamber side and that the spark plug is a pre-chamber spark plug, wherein the pre-chamber has a volume V.

In a development of the spark plug as a pre-chamber spark plug, it is advantageous if the insulator protrudes with a length L into the pre-chamber, wherein the length L extends, in parallel with the longitudinal axis X of the spark plug, from the end of an internal seal, arranged between the insulator and the housing, on the combustion chamber side to the end of the insulator on the combustion chamber side, and that the ratio V/L of the pre-chamber volume V to the length L of the insulator is equal to or greater than 75 mm² and equal to or less than 200 mm², in particular equal to or greater than 100 mm² and/or equal to or less than 150 mm². This results in the insulator not absorbing too much heat from the pre-chamber and at the same time not being too cool, so that undesirable deposits are not formed on the insulator.

### BRIEF DESCRIPTION OF THE DRAWINGS

FIG. 1 shows an example of a spark plug according to an embodiment of the present invention with a ground electrode.

FIG. 2 shows a second example for a spark plug according to an example embodiment of the present invention with two ground electrodes

### DETAILED DESCRIPTION OF EXAMPLE EMBODIMENTS

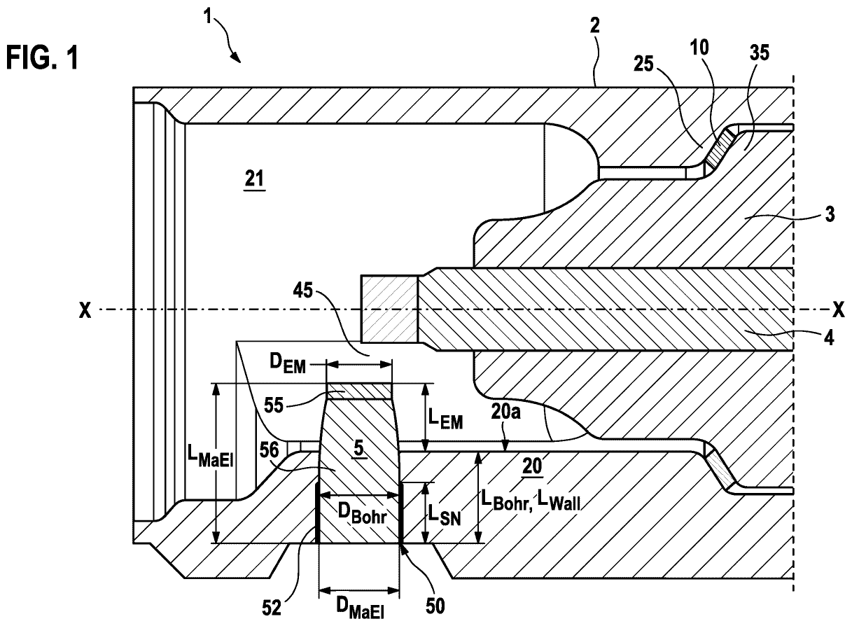

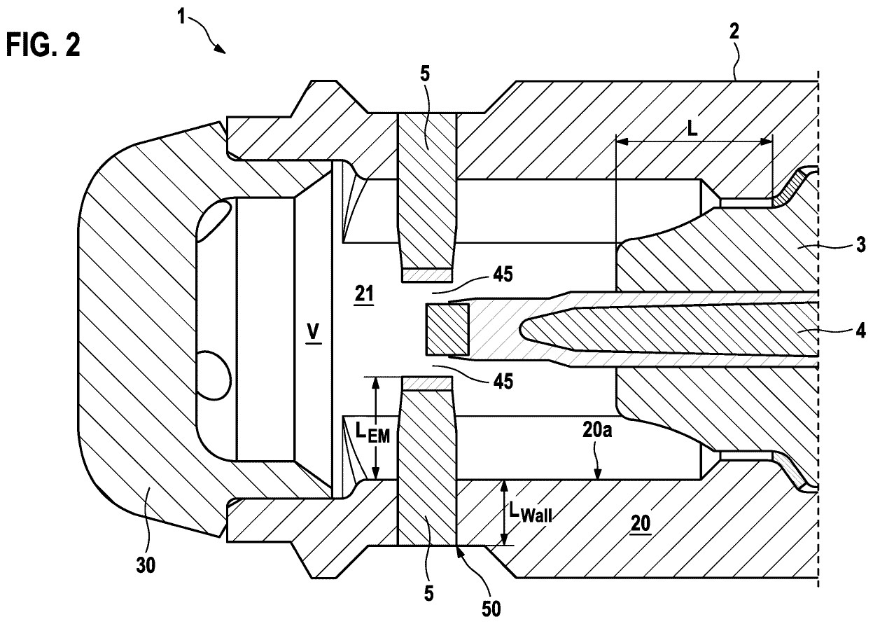

FIGS. 1 and 2 show two exemplary embodiments of the spark plug 1 according to the present invention. The half of the spark plug 1 on the combustion chamber side is shown in a sectional view in each case. The two exemplary embodiments differ substantially in that FIG. 1 shows a spark plug 1 with a ground electrode 5 and FIG. 2 shows a spark plug 1 with two ground electrodes. FIG. 2 shows the optional cap 30 at the end of the housing on the combustion chamber side. The exemplary embodiment according to FIG. 2 may also be realized without a cap. Accordingly, the exemplary embodiment according to FIG. 1 may also be realized with a cap 30.

The spark plug 1 according to the present invention has a longitudinal axis X. The spark plug 1 comprises a housing 2. An insulator 3 is inserted in the housing 2. The housing 2 and the insulator 3 each have a longitudinal bore along their longitudinal axis. The housing 2 has a housing wall 20 and an interior 21.

A center electrode 4 is arranged in the insulator 3. The spark plug 1 has a ground electrode 5 with a length L_{MaEl} and a diameter D_{MaEl}, Wherein the length of the ground electrode 5 is, for example, 2 mm to 4 mm and the diameter is, for example, 1 mm to 2 mm. The center electrode 4 and the ground electrode 5 are arranged relative to each other such that a spark gap 45 is formed. For example, the spark gap 45 is formed as a radial spark gap. Preferably, the spark gap 45 is at least partially, in particular entirely, formed in the interior 21 of the housing 2.

For example, the ground electrode 5 may comprise a precious-metal-containing element 55 that forms the end of the ground electrode 5 on the spark gap side. If the ground electrode 5 comprises a precious-metal-containing element 55, the ground electrode 5 is composed of an electrode base body 56 and the precious-metal-containing element 55, wherein the precious-metal-containing element 55 is attached to the electrode base body 56. The precious-metal-containing element 55 has a diameter D_{EM} of 0.6 to 1.1 mm. The ratio of D_{EM} to D_{MaEl} is 0.4 to mm, in particular 0.55 to 0.6 mm, which results in the different coefficients of thermal expansion of the precious-metal-containing element 55 and of the electrode base body 56, which may, for example, consist of a nickel alloy, being balanced.

The diameter D_{MaEl} of the ground electrode 5 is measured at its thickest point or at the thickest point of the electrode base body 56. This thickest point is typically in the portion of the ground electrode 5 that is arranged within the bore 50 of the housing 2.

The housing 2 has at least one bore 50 in the housing wall 20 with a diameter D_{Bohr}; for example, D_{Bohr} is 1 mm to 2 mm. The housing wall 20 in the region of the bore 50 has a thickness L_{Wall}; for example, L_{Wall} is 1.5 to 2.5 mm. The ground electrode 5 is arranged in this bore 50. The ground electrode 5 is with a length L_{Bohr} in the bore 50. The ground electrode 5 protrudes with a length Lₑₘ from the inner side 20a of the housing 2 into the interior 21 of the housing 2. The sum of the lengths L_{Bohr} and L_{Em} is the total length of the ground electrode L_{MaEL}. For example, the length L_{Bohr} is 1 to 2 mm. For example, the length L_{Em} is 0.6 to 1.6 mm. For example, the length L_{MaEl} is 1.6 to 3.6 mm.

For a spark plug 1 with a good heat balance, the following ratios have been found to be advantageous:

$${L}_{MaE 1} / {L}_{Bohr} = 1.8 to 2.2$$

$${L}_{EM} / {L}_{Wall} = 0.2 to 3$$

In this example, the ground electrode 5 is welded to the housing wall 20 in the bore 50. The weld seam 52 is formed along the circumference of the ground electrode 5. The weld seam 52 extends from the outer side of the housing 2 in the direction of the longitudinal axis X of the spark plug. The weld seam 52 has a length L_{SN}, which is advantageously less than the thickness L_{Wall} of the housing wall 20 so that the weld seam 52 does not extend to the inner side of the housing 2.

Furthermore, the housing 2 comprises a seat 25 on its inner side. The insulator 3 rests with its shoulder, or insulator seat 35, on the housing seat 25. An internal seal 10 is arranged between the insulator seat 35 and the housing seat 25. From the end of the internal seal on the combustion chamber side to the end of the insulator 3 on the combustion chamber side, the insulator 3 protrudes with a length L into the interior 21 of the housing 2. For example, the length L of the insulator 3 is 2.5 to 5.5 mm.

As shown by way of example in FIG. 2, a cap 30 may be arranged on the end face of the housing 2 on the combustion chamber side. The housing 2 and the cap 30 together form a pre-chamber with a pre-chamber volume V. The volume V is, for example, 200 to 600 mm³. The length L of the insulator and the volume V are advantageously coordinated with one another such that a ratio V/L is in the range of 75 to 200 mm².

1-13. (canceled)

14. A spark plug with a longitudinal axis, comprising:
a housing with a longitudinal bore parallel to the longitudinal axis of the spark plug, the housing having a housing wall and an interior;
an insulator arranged within the housing;
a center electrode arranged within the insulator;
a ground electrode with a total length L_{MaEl} and a diameter D_{MaEl},
a bore in the housing wall with a diameter D_{Bohr}, wherein the ground electrode is arranged with a length L_{Bohr} in the bore, and the ground electrode projects with a length Lₑₘ from an inner side of the housing wall into the interior of the housing, and wherein the housing wall has a thickness L_{Wall} in a region of the bore; and
a spark gap formed between the ground electrode and the center electrode;
wherein: (i) a ratio of the total length L_{MaEl} of the ground electrode to the length L_{Bohr} of the ground electrode in the bore is equal to or greater than 1.8 and equal to or less than 2.2, and/or (ii) the ratio of the length Lₑₘ, with which the ground electrode projects into the interior of the housing, to the thickness L_{Wall} of the housing wall is equal to or greater than 0.2 and is equal to or less than 3, wherein the total length L_{MaEl} of the ground electrode, the length L_{Bohr} of the ground electrode in the bore, the length Lₑₘ with which the ground electrode projects into the interior of the housing, and the thickness L_{Wall} of the housing wall, extend perpendicularly to the longitudinal axis of the spark plug.

15. The spark plug according to claim 14, wherein the ratio of the length Lₑₘ, with which the ground electrode projects into the interior of the housing, to the thickness L_{Wall} of the housing wall is equal to or less than 2.

16. The spark plug according to claim 14, wherein the ground electrode has a total length L_{MaEL} of equal to or greater than 2.0 mm and equal to or less than 4.0 mm.

17. The spark plug according to claim 14, wherein the length L_{Bohr} of the ground electrode in the bore and/or the thickness L_{Wall} of the housing wall, is equal to or greater than 1.0 mm and equal to or less than 2.5 mm.

18. The spark plug according to claim 14, wherein the length L_{Bohr} of the ground electrode in the bore is equal to the thickness L_{Wall} of the housing wall.

19. The spark plug according to claim 14, wherein the ground electrode protrudes with a length Lₑₘ of equal to or greater than 0.6 mm and equal to or less than 1.6 mm into the interior.

20. The spark plugs according to claim 14, wherein the ground electrode includes an electrode base body, which is at least partially arranged within the bore and has a diameter D_{MaEl} within the bore, and a precious-metal-containing element with a diameter D_{EM}, which precious-metal-containing element is attached to the electrode base body, wherein a ratio between the diameter D_{EM} of the precious-metal-containing element and the diameter D_{MaEl} of the electrode base body in the bore is equal to or less than 1 and equal to or greater than 0.4.

21. The spark plug according to claim 14, wherein: (i) the spark gap between the center electrode and the ground electrode is a radial spark gap, and/or (ii) the spark gap is at least partially formed within the interior of the housing.

22. The spark plug according to claim 14, wherein the ground electrode is welded to the housing wall in the bore so that a weld seam that has a length L_{SN} of less than or equal to 0.9*L_{Wall} and greater than or equal to 0.3*L_{Wall} is between the ground electrode and the housing wall.

23. The spark plug according to claim 14, wherein a magnitude of a difference between the diameter D_{Bohr} and the diameter D_{MaEl} is equal to or less than 0.03 mm.

24. The spark plug according to claim 14, wherein the spark plug has a second ground electrode that is arranged in a further bore in the housing wall.

25. The spark plug according to claim 14, wherein the spark plug has a cap, which is attached to an end of the housing on a combustion chamber side, and the spark plug is a pre-chamber spark plug, wherein the pre-chamber has a volume V.

26. The spark plug according to claim 25, wherein the insulator protrudes with a length L into the pre-chamber, wherein the length L extends, in parallel with the longitudinal axis of the spark plug, from an end of an internal seal, arranged between the insulator and the housing, on the combustion chamber side to an end of the insulator on the combustion chamber side, and wherein the ratio V/L of the pre-chamber volume V to the length L of the insulator is equal to or greater than 75 mm² and equal to or less than 200 mm².
